(19) United States
(12) Patent Application Publication
(10) Pub. No.: US 2020/0342588 A1
(43) Pub. Date: Oct. 29, 2020

(54) Methods for Determining Biological Relevance of Object Clustering Within Tissue Samples

(71) Applicant: Flagship Biosciences, Inc., Westminster, CO (US)

(72) Inventors: Charles Caldwell, Jr., Denver, CO (US); Joseph Krueger, Andover, MA (US); Will Paces, Denver, CO (US)

(73) Assignee: Flagship Biosciences, Inc., Westminster, CO (US)

(21) Appl. No.: 16/395,911

(22) Filed: Apr. 26, 2019

(51) Int. Cl. G06T 7/00; G01N 1/30

(52) U.S. Cl. CPC G06T 7/0012; G06K 9/00147; G06T 2207/30024; G01N 1/30

(57) ABSTRACT

Digital image analysis can simultaneously measure many multidimensional features of each data point within an image. Each data point can then be grouped into categories, or ‘clusters’, of data points by assessing all features of each data point and measuring similarity among all data points. Clustering multidimensional data allows one to visualize the structure of their data and visually represent groups of data points in a lower dimensional space, such as a 2D or 3D graph. If the data points are not tagged with a description before clustering, it is difficult to assess which data points belong to which cluster. In this method, we describe the clustering of tissue objects (data points) into clusters based on their image analysis features, then creating a cluster map in order to describe tissue objects based on cluster association.

### BACKGROUND

### Field of the Invention

The present invention relates generally to image analysis methods for the assessment of tissue samples. More specifically, the present invention relates to image analysis methods for the evaluation of tissue objects within a tissue sample based on image analysis feature clustering within those tissue objects.

### Description of the Related Art

Several methods exist which allow grouping of data points into categories based on their measured similarities. Current big data trends simultaneously measure hundreds to thousands of features or ‘dimensions’ of each data point. Multidimensional data clustering takes in to account every feature of a data point in order to group the data in to categories of similarity. Methods such as K means, HDB SCAN, and t-SNE are some of the most popular multidimensional data clustering algorithms in use today. Many of these methods are used solely for the purpose of visualizing graphic representations of the organization of the data itself.

### SUMMARY

In accordance with the embodiments herein, a method for analyzing tissue objects using image analysis feature clustering is disclosed. The method described herein generally utilizes digital image analysis of tissue objects within a digital image of at least one tissue sample. The tissue objects have one or more common image analysis features extracted from the image and are then grouped into clusters based on the commonalities of the image analysis feature or features. These individual clusters are then used to generate a cluster map, which can be used to coordinate the tissue object clusters with the location of the clustered tissue objects within the digital images. Each tissue object is identified in the original image based on the category in to which the object has been clustered.

### BRIEF DESCRIPTION OF THE DRAWINGS

FIG. 1 provides a general overview of the method herein described.

FIG. 2 shows an example of clustering within a digital image of a tissue sample.

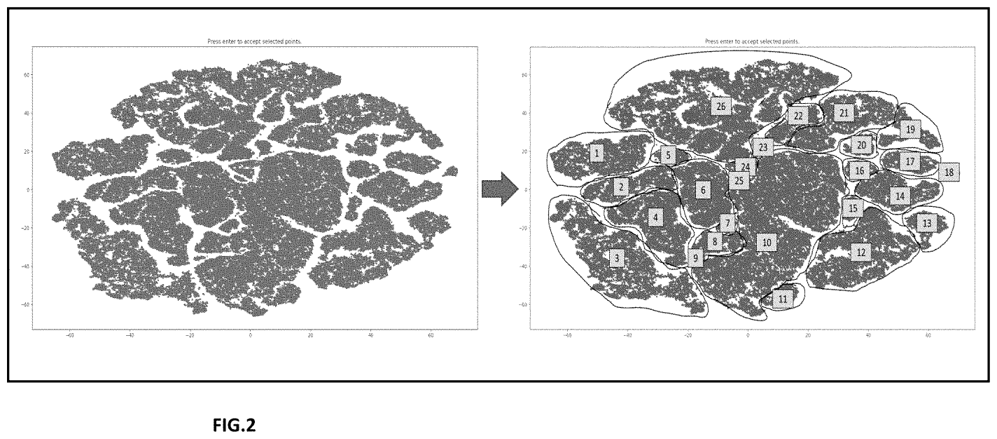

FIG. 3 provides a sample of the data set extracted from selected clusters for a number of individual image analysis features within the tissue sample.

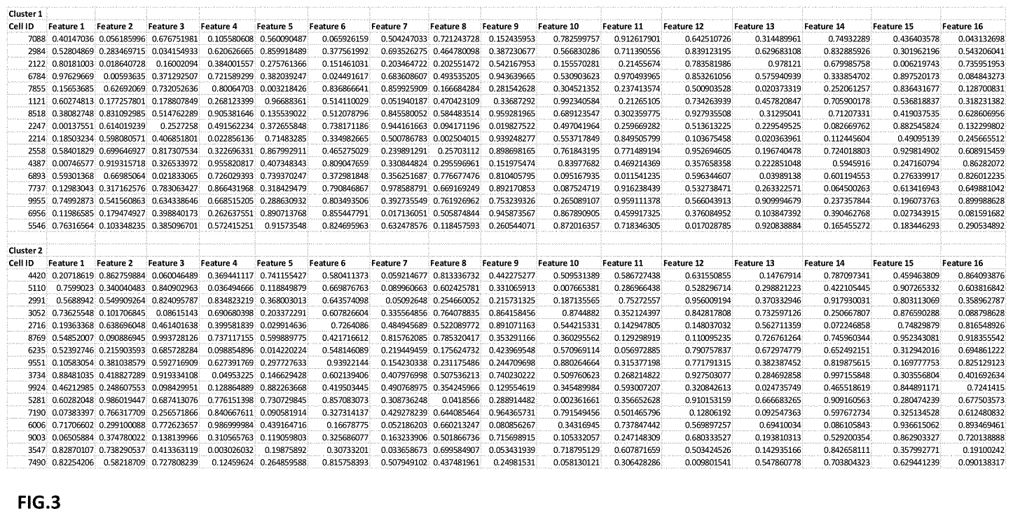

FIG. 4 illustrates one example of a cluster map for four separate clusters overlain on the original digital image.

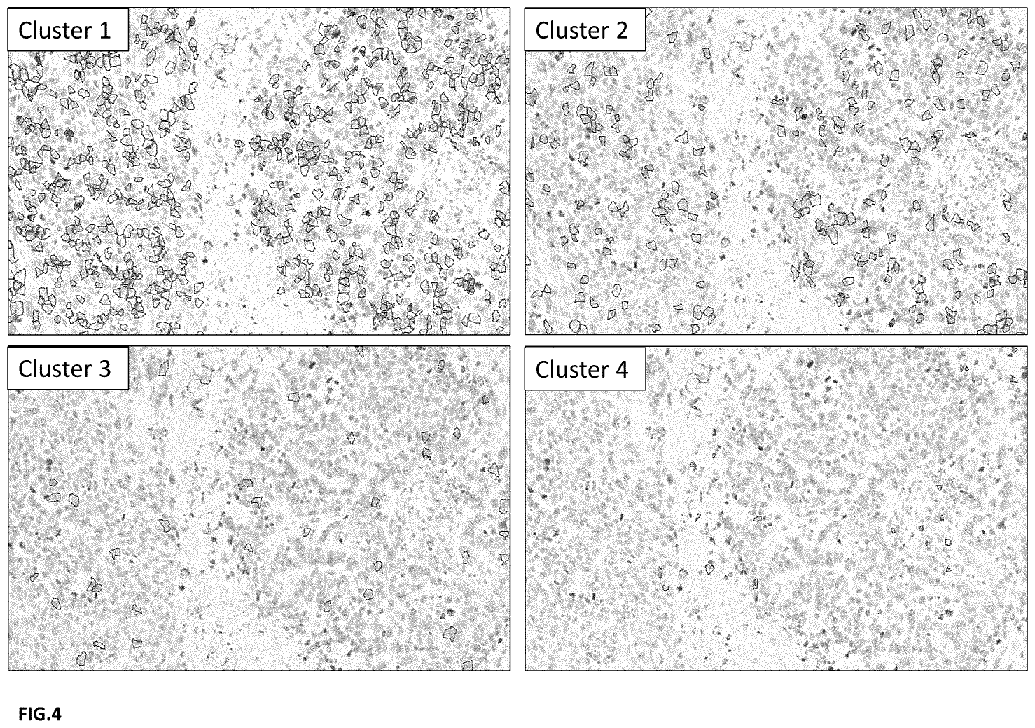

FIG. 5 illustrates one example of a cluster map used for two different clusters overlain on the original digital images of multiple tissue sections.

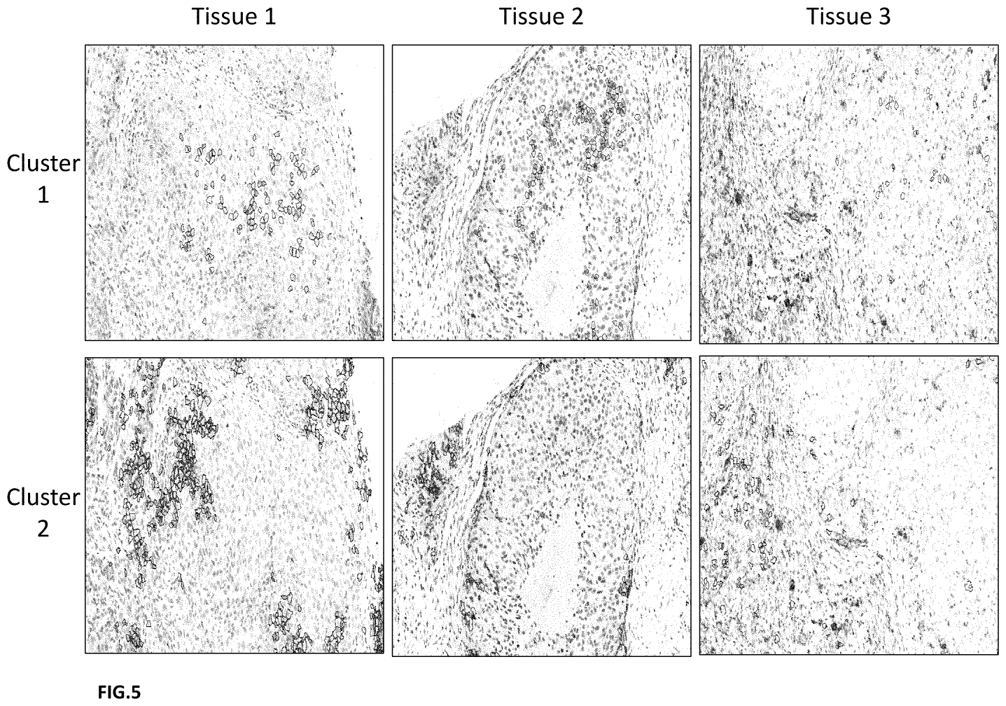

### DETAILED DESCRIPTION OF EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions without departing from the spirit and scope of the invention.

For purpose of definition, a tissue object is one or more of a cell (e.g., immune cell), cell sub-compartment (e.g., nucleus, cytoplasm, membrane, organelle), cell neighborhood, a tissue compartment (e.g., tumor, tumor microenvironment (TME), stroma, lymphoid follicle, healthy tissue), blood vessel, a lymphatic vessel, vacuole, collagen, regions of necrosis, extra-cellular matrix, a medical device (e.g., stent, implant), a gel, a parasitic body (e.g., virus, bacterium), a nanoparticle, a polymer, and/or a non-dyed object (e.g., metal particle, carbon particle). Tissue objects are visualized by histologic stains which highlight the presence and localization of a tissue object. Tissue objects can be identified directly by stains specifically applied to highlight the presence of said tissue object (e.g., hematoxylin to visualize nuclei, IHC stain for a protein specifically found in a muscle fiber membrane), indirectly by stains applied which non-specifically highlight the tissue compartment (e.g., DAB background staining), are biomarkers known to be localized to a specific tissue compartment (e.g., nuclear-expressed protein, carbohydrates only found in the cell membrane), or can be visualized without staining (e.g., carbon residue in lung tissue).

For the purpose of this disclosure, patient status includes diagnosis of inflammatory status, disease state, disease severity, disease progression, therapy efficacy, and changes in patient status over time. Other patient statuses are contemplated.

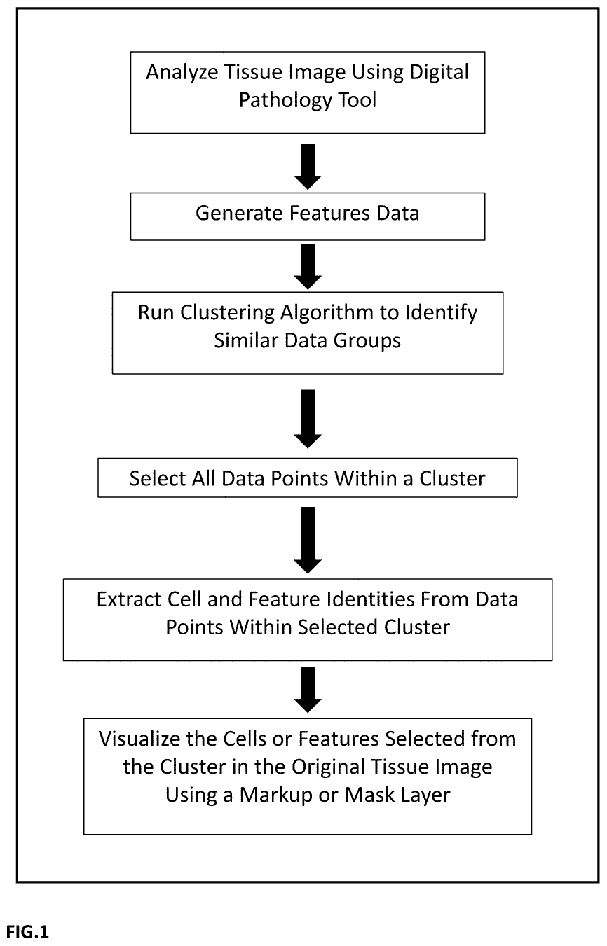

In an illustrative embodiment of the invention, as summarized in FIG. 1, the method may be summarized in the following four steps: i) acquiring a digital image of a tissue sample; ii) extracting the image analysis features from the tissue objects within the digital image using a computer system; iii) grouping the tissue objects into tissue object clusters based on the similarities of the extracted image analysis features; and iv) generating a cluster map through coordination of at least one of the tissue object clusters with the location of the clustered tissue objects within the digital image. Typically, a tissue sample will be stained with a number of stains to ensure that the tissue objects within the sample will be easily distinguishable. It is understood, however, that staining a sample is not required for the method to function.

In a second illustrative embodiment of the invention, the method may be summarized in the following four steps: i) acquiring a digital image of each of a plurality of tissue samples; ii) extracting image analysis features from the tissue objects with the digital images using a computer system; iii) grouping the tissue objects into tissue object clusters based on the similarities of the extracted image analysis features; and iv) generating at least one cluster map for at least one of the digital images through coordination of at least one of the tissue object clusters with the location of the clustered tissue objects within the digital image. As with the previous embodiment, the plurality of tissue samples will typically be stained with a number of stains to ensure that the tissue objects with the samples will be easily distinguishable. However, it is understood that staining the samples is not required for the method to function.

In a further embodiment, the image analysis features include morphometric features, localization features, neighborhood features, and staining features of the tissue objects within the tissue sample. Morphometric features are features related to the size, shape, area, texture, organization, and organizational relationship of tissue objects observed in a digital image. For example, and not limitation, morphometric features could be the area of a cell nucleus, the completeness of biomarker staining in a cell membrane, the diameter of a cell nucleus, the roundness of a blood vessel, lacunarity of biomarker staining in a nucleus, etc.

Localization features are features related to position of a feature in the tissue section, spatial relationships of tissue objects relative to each other, relationship of image analysis features between tissue objects in the tissue section, and distribution of image analysis features within a tissue object. Location can be determined based on an absolute (x and y location based on pixel dimensions of image, μm from center of image defined by pixel dimensions of image) or relative (e.g., x and y position of cells relative to a tissue feature of interest such as a vessel, polar coordinates referenced to the center of mass of a tumor nest) coordinate system (e.g., x-y-z coordinates, polar coordinates). Location for specific image objects can be defined as the centroid of the object or any position enclosed by the object extending from the centroid to the exterior limits of the object.

Neighborhood features are features related to tissue object morphology within a distance of an anchor tissue object, tissue object staining within a distance of an anchor tissue object, and morphology and/or staining between tissue objects within a distance of an anchor tissue object. For example, and not limitation, neighborhood features could be the average size or area of cells within 100 microns of an anchor cell or the quality or quantity of staining of cell nuclei within 500 microns of an anchor cell nucleus.

Staining features are features related to stain appearance, stain intensity, stain completeness, stain shape, stain texture, stain area, and stain distribution of specified IHC, ISH, and IF stains or dyes or amount of a molecule determined by MSI-based methodologies. Staining features are evaluated relative to tissue objects (e.g., average staining intensity in each cell in an image, staining level in a cell membrane, biomolecule expression in a nucleus).

In another embodiment, the cluster map can be a chart of data points taken from the feature cluster, a graphical representation of a chart of data points taken from the feature cluster, or a digital image of the feature cluster. The graphical cluster maps, the graphical representation, or the digital image, can be overlaid on top of the digital image of the tissue sample, or samples, such that the cluster map highlights the underlying tissue objects in the tissue sample.

In a further embodiment, the cluster map can be used to assign the tissue objects biological descriptions, such as a cell type, structural formation of cells, disease state, or features of clinical or anatomical pathology.

In another embodiment, the cluster map is used to calculate a score for each patient from whom the tissue samples were taken. This score is then used to determine the patient status for that patient. This can be performed both when the method is used for a single tissue section or for a plurality of tissue sections, such that how the cluster map is developed is agnostic to the determination of patient status for each patient.

What is claimed is:

1. A method, comprising:
acquiring a digital image of a tissue sample;
extracting at least one image analysis feature from each of at least two tissue objects in the digital image using a computer system, wherein the tissue objects have a location within the digital image;
grouping the at least two extracted tissue objects into at least one tissue object cluster based on similarities of the extracted image analysis features; and
generating at least one cluster map through coordination of at least one of the tissue object clusters with the location of the clustered tissue objects within the digital image.

2. The method of claim 1, wherein the tissue sample is stained with at least one stain.

3. The method of claim 1, wherein the at least one image analysis feature is selected from the group consisting of morphometric features, localization features, neighborhood features, and staining features.

4. The method of claim 3, wherein the morphometric features are selected from the group consisting of size, shape, area, texture, organization, and organizational relationship.

5. The method of claim 3, wherein the localization features are selected from the group consisting of position of a feature in the tissue section, the spatial relationships of tissue objects relative to each other, relationship of image analysis features between different tissue objects in the tissue section, and distribution of image analysis features within a tissue object.

6. The method of claim 3, wherein the neighborhood features are selected from the group consisting of tissue object morphology within a distance of an anchor tissue object, tissue object staining within a distance of an anchor tissue object, morphology of the space between tissue objects within a distance of an anchor tissue object, and staining of the space between tissue objects within a distance of an anchor tissue object.

7. The method of claim 3, wherein the staining features are selected from the group consisting of stain appearance, stain intensity, stain completeness, stain shape, stain texture, stain area, and stain distribution.

8. The method of claim 1, wherein the cluster map is selected from the group consisting of a chart of data points, a graphical representation of a chart of data points, and a digital image of the feature cluster.

9. The method of claim 1, further comprising using the cluster map to assign the tissue objects biological descriptions.

10. The method of claim 1, further comprising:
using the cluster map, calculating a patient-specific score for the digital image based on the at least one tissue object cluster; and
determining at least one patient status for a patient from whom the tissue section was acquired based on the patient-specific score.

11. The method of claim 10, wherein the at least one patient status is selected from the group consisting of inflammatory status, disease state, disease severity, disease progression, therapy efficacy, and changes in patient status over time.

12. A method, comprising:
acquiring a digital image of each of a plurality of tissue samples;
extracting at least one image analysis feature from each of at least two tissue objects in each digital image using a computer system, wherein the tissue objects have a location within their respective digital image;
grouping the extracted image analysis features into at least one tissue object cluster for each digital image based on similarities of the extracted image analysis features across a cohort of the digital images; and
generating at least one cluster map for at least one of the digital images through coordination of at least one of the tissue object clusters with the location of the clustered tissue objects within the digital image.

13. The method of claim 12, wherein the plurality of tissue samples are stained with at least one stain.

14. The method of claim 12, wherein the at least one image analysis feature is selected from the group consisting of morphometric features, localization features, neighborhood features, and staining features.

15. The method of claim 14, wherein the morphometric features are selected from the group consisting of size, shape, area, texture, organization, and organizational relationship.

16. The method of claim 14, wherein the localization features are selected from the group consisting of position of a feature in the tissue section, the spatial relationships of tissue objects relative to each other, relationship of image analysis features between different tissue objects in the tissue section, and distribution of image analysis features within a tissue object.

17. The method of claim 14, wherein the neighborhood features are selected from the group consisting of tissue object morphology within a distance of an anchor tissue object, tissue object staining within a distance of an anchor tissue object, morphology of the space between tissue objects within a distance of an anchor tissue object, and staining of the space between tissue objects within a distance of an anchor tissue object.

18. The method of claim 14, wherein the staining features are selected from the group consisting of stain appearance, stain intensity, stain completeness, stain shape, stain texture, stain area, and stain distribution.

19. The method of claim 12, wherein the cluster map is selected from the group consisting of a chart of data points, a graphical representation of a chart of data points, and a digital image of the feature cluster.

20. The method of claim 12, further comprising using the cluster map to assign the tissue objects biological descriptions.

21. The method of claim 12, further comprising:
using the cluster map, calculating a patient-specific score for at least one of the digital images based on the at least one feature cluster for that digital image; and
determining at least one patient status for a patient from whom the tissue section was acquired to generate the specific digital image based on the patient-specific score.

22. The method of claim 20, wherein the at least one patient status is selected from the group consisting of inflammatory status, disease state, disease severity, disease progression, therapy efficacy, and changes in patient status over time.
